(19) United States
(12) Patent Application Publication
(10) Pub. No.: US 2025/0348184 A1
(43) Pub. Date: Nov. 13, 2025

(54) MAP AREA SHARING METHOD AND APPARATUS, AND ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Rui HU, Shenzhen (CN); Jiayin Zhang, Shenzhen (CN)

(73) Assignee: Tencent Technology (Shenzhen) Company Limited, Shenzhen (CN)

(21) Appl. No.: 19/276,302

(22) Filed: Jul. 22, 2025

Related U.S. Application Data
(63) Continuation of application No. PCT/CN2024/094010, filed on May 17, 2024.

(30) Foreign Application Priority Data
Jul. 5, 2023 (CN) 202310820759.3

(51) Int. Cl. G06F 3/0481; G01C 21/00; G06F 3/04845

(52) U.S. Cl. CPC G06F 3/0481; G01C 21/3804; G06F 3/04845

(57) ABSTRACT

A map area sharing method, apparatus, and computer-readable storage medium for sharing map areas through interactive interfaces. The method displays a dynamic image and sharing channel selection box based on a map area sharing operation performed on a target map area. The dynamic image comprises multiple frames, each corresponding to a new map area generated by adjusting the target map area according to a preset ratio. A to-be-shared map area is determined based on an area adjustment operation performed on the target map area. A shared image comprising the to-be-shared map area is generated based on selection of a sharing channel from the selection box. The shared image is then shared to a shared object in the selected sharing channel, enabling efficient map area sharing with dynamic visualization.

### CROSS-REFERENCE TO RELATED APPLICATIONS

This application is a continuation application of International Application No. PCT/CN2024/094010 filed on May 17, 2024 which claims priority to Chinese Patent Application No. 202310820759.3, filed with the China National Intellectual Property Administration on Jul. 5, 2023, the disclosures of each being incorporated by reference herein in their entireties.

### FIELD

The disclosure relates to the field of Internet, a map area sharing method and apparatus, an electronic device, an apparatus and a computer-readable storage medium.

### BACKGROUND

In the related art, with the development of map products, when a user takes a screenshot on a home page of a map application, the current map application supports the user to quickly share a screenshot image of the page or supports the user to share a particular subject map, for example, a fever outpatient department map.

However, none of the related art supports a sharing user who shares a map area to manually adjust a shared area, for example, none of the related art supports a user to manually adjust a map area range that the user intends to share, or supports the sharing user to directly scan a code to view a shared map area range. Therefore, if the sharing user needs to adjust the screenshot image of the page, the sharing user needs to delete the screenshot to reenter a current interface of the map application, and take a screenshot again after adjusting the page subjected to the screenshot taking. Apparently, this imposes a great waste on resources (including computing resources and communication resources of a back-end server) of the map application.

In conclusion, how to expand a deep and efficient map area screenshot sharing mode in a map application system in a resource-intensive manner, to improve map area sharing quality. There is still no effective solution in the related art.

### SUMMARY

Provided are a map area sharing method and apparatus, a device, a storage medium, and a program product, which can implement efficient sharing of map areas through dynamic image generation and interactive channel selection.

According to some embodiments, a map area sharing method, performed by an electronic device, includes: displaying, based on a map area sharing operation performed on a target map area, a dynamic image and a sharing channel selection box on an interface of a map application, wherein the target map area is a local map area in the map application, the dynamic image comprises a plurality of frames of images, and each frame of image corresponds to a new map area generated based on adjusting the target map area according to a preset ratio; determining a to-be-shared map area based on an area adjustment operation performed on the target map area; generating a shared image comprising the to-be-shared map area based on a selection operation of a sharing channel from the sharing channel selection box; and sharing the shared image to a shared object in the sharing channel.

According to some embodiments, a map area sharing apparatus, includes: at least one memory configured to store program code; and at least one processor configured to read the program code and operate as instructed by the program code, the program code including: displaying code configured to cause at least one of the at least one processor to display, based on a map area sharing operation performed on a target map area, a dynamic image and a sharing channel selection box on an interface of a map application, wherein the target map area is a local map area in the map application, the dynamic image comprises a plurality of frames of images, and each frame of image corresponds to a new map area generated based on adjusting the target map area according to a preset ratio; determining code configured to cause at least one of the at least one processor to determine a to-be-shared map area based on an area adjustment operation performed on the target map area; generating code configured to cause at least one of the at least one processor to generate a shared image comprising the to-be-shared map area based on a selection operation of a sharing channel from the sharing channel selection box; and sharing code configured to cause at least one of the at least one processor to share the shared image to a shared object in the sharing channel.

According to some embodiments, a non-transitory computer-readable storage medium, storing computer code which, when executed by at least one processor, causes the at least one processor to at least: display, based on a map area sharing operation performed on a target map area, a dynamic image and a sharing channel selection box on an interface of a map application, wherein the target map area is a local map area in the map application, the dynamic image comprises a plurality of frames of images, and each frame of image corresponds to a new map area generated based on adjusting the target map area according to a preset ratio; determine a to-be-shared map area based on an area adjustment operation performed on the target map area; generate a shared image comprising the to-be-shared map area based on a selection operation of a sharing channel from the sharing channel selection box; and share the shared image to a shared object in the sharing channel.

### BRIEF DESCRIPTION OF THE DRAWINGS

FIG. 1 is a schematic diagram of a selectable architecture of a map area sharing system according to some embodiments.

FIG. 2 is a schematic structural diagram of an electronic device according to some embodiments.

FIG. 3 is a selectable flowchart of a map area sharing method according to some embodiments.

FIG. 4 is another selectable flowchart of a map area sharing method according to some embodiments.

FIG. 5 is a flowchart of implementation of generating a dynamic to-be-shared image according to some embodiments.

FIG. 6 is still another selectable flowchart of a map area sharing method according to some embodiments.

FIG. 7 is a flowchart of implementing a map area sharing method through interaction between a terminal and a server according to some embodiments.

FIG. 8 is a schematic diagram of an implementation process of adjusting a size and position of a plotting scale of a to-be-shared map area according to some embodiments.

FIG. 9 is a schematic diagram of an implementation process of scanning a code to open and view a map that has the same area as that in a shared image according to some embodiments.

FIG. 10 is a diagram of an interface that supports presentation of user login information and edited description information according to some embodiments.

FIG. 11 is a flowchart of implementation of an interactive map sharing function according to some embodiments.

FIG. 12 is a flowchart of an improved mode for performing a map sharing operation according to some embodiments.

FIG. 13 is a flowchart of another improved mode for performing a map sharing operation according to some embodiments.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict. Unless otherwise defined, meanings of all technical and scientific terms used in some embodiments are the same as those usually understood by a person skilled in the art to which some embodiments belong. Terms used in some embodiments are merely intended to describe objectives of some embodiments, but are not intended to limit this application. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the related art, when a user shares a map area (i.e., a map area), the shared map area cannot be adjusted and edited, so that the shared map area cannot accurately convey an area range desired by the sharing user. In addition, a shared user cannot view an accurate map area range, and cannot implement accurate conveying of shared information in an entire sharing link.

In view of the foregoing problem, some embodiments provides a map area sharing method. According to the method, based on analysis on a user sharing a map screenshot, it is found that the user has a demand for sharing and viewing an accurate shared map area. Adding interactivity to a shared map area is used as a new operation mode, to optimize a sharing procedure and accurately express information about a to-be-shared map area. In addition, an area recognition capability is added into a two-dimensional code link of the shared map area, so that area ranges viewed by the shared user and the sharing user are displayed in a consistent manner, so that map area shared information is effectively conveyed, and a geographical position range is accurately shared.

In the map area sharing method according to some embodiments, first, in response to a map area sharing operation performed on a target map area being received, a dynamic to-be-shared image corresponding to the target map area and a sharing channel selection box are displayed on a current interface of a map application. The target map area is a local map area in the map application. The dynamic to-be-shared image includes a plurality of frames of images, and each frame of image is an image of a new map area generated after area adjustment in a preset ratio is performed on the target map area in the map application. Then, in response to an area adjustment operation performed on the target map area, a to-be-shared map area corresponding to the area adjustment operation is determined. In response to a selection operation performed on any sharing channel in the sharing channel selection box, a shared image including the to-be-shared map area is generated. Finally, the shared image is shared to a shared object in the sharing channel. In this way, the dynamic to-be-shared image corresponding to the target map area is displayed when a user performs map area sharing, and the user can perform area adjustment on the target map area, thereby supporting, in the map application, the user to manually adjust the target map area. The user is supported to manually adjust a map area range that the user intends to share. In this way, a deep and efficient map area screenshot sharing mode can be expanded in a map application system in a resource-intensive manner.

According to some embodiments, an map area sharing device is an electronic device for implementing the map area sharing method. In an implementation, the map area sharing device according to some embodiments may be implemented as a terminal. The terminal may be implemented as any terminal having a map display function such as a notebook computer, a tablet computer, a desktop computer, a mobile phone, a portable music player, a personal digital assistant, a dedicated message device, a portable game device, a smart robot, a smart home appliance, or a smart in-vehicle device, or may be a terminal having a navigation function.

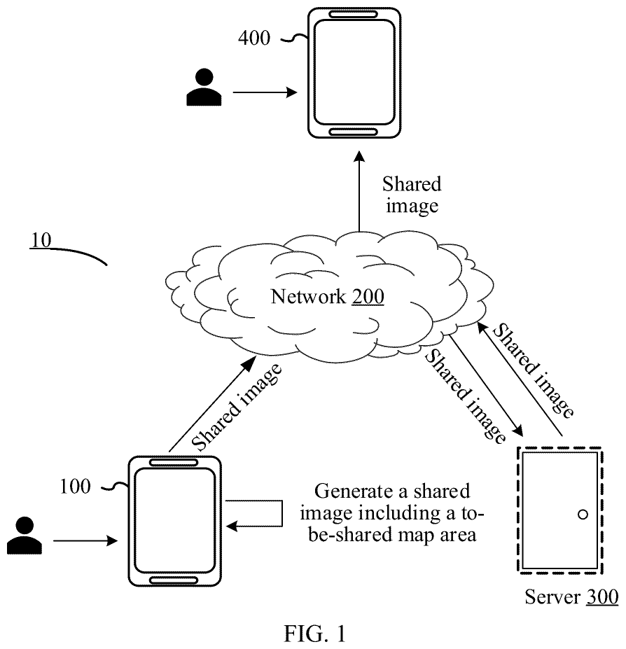

FIG. 1 is a schematic diagram of a selectable architecture of a map area sharing system according to some embodiments. Some embodiments takes an example in which a map area sharing method is applied to any map application for explanation. The map application is deployed in a terminal. In a running process of the map application, a series of sharing operations of a user may be received through a client of the map application, so that a map area selected by the user is shared to a shared object. In some embodiments, the map area sharing system 10 at least includes a terminal 100, a network 200, a server 300, and a peer end 400 corresponding to the shared object. The server 300 may be a back-end server of the map application. The terminal 100 may constitute a map area sharing device according to some embodiments. The terminal 100 is connected to the server 300 through the network 200. The network 200 may be a wide area network, a local area network, or a combination of a wide area network and a local area network.

In some embodiments, the map application is installed in the terminal 100. In a process in which a user enters the map application through the client of the map application and runs the map application, an operation performed by the user on the terminal may be received through the client of the map application. When the terminal 100 receives a map area sharing operation performed by the user on a target map area, the terminal 100 displays, on a current interface of the map application, a dynamic to-be-shared image corresponding to the target map area and a sharing channel selection box. The target map area here is a local map area in the map application. The dynamic to-be-shared image includes a plurality of frames of images, and each frame of image is an image corresponding to a new map area generated after area adjustment in a preset ratio is performed on the target map area in the map application. When the terminal 100 receives an area adjustment operation performed on the target map area, the terminal 100 determines a to-be-shared map area corresponding to the area adjustment operation. When receiving a selection operation performed on any sharing channel in the sharing channel selection box, the terminal 100 generates a shared image including the to-be-shared map area. Then, the shared image is transmitted to the server 300 through the network 200, and the server 300 shares the shared image to a shared object in the sharing channel, for example, transmits the shared image to the peer end 400 corresponding to the shared object.

In some embodiments, the map area sharing method may be complemented by interaction between a terminal and a server. The terminal 100 may receive a map area sharing operation, an area adjustment operation, and a selection operation of a user. When receiving any one of the map area sharing operation, the area adjustment operation, and the selection operation, the terminal 100 transmits the map area sharing operation, the area adjustment operation, or the selection operation to the server. The server 300 makes a response to the map area sharing operation, the area adjustment operation, and the selection operation respectively. The server 300 respectively determines a dynamic to-be-shared image corresponding to a target map area, determines a to-be-shared map area corresponding to the area adjustment operation, and generates a shared image including the to-be-shared map area.

The map area sharing method according to some embodiments may be implemented based on a cloud platform and a cloud technology. For example, the above server 300 may be a cloud server. The cloud server shares the shared image to the shared object corresponding to the sharing channel. In some embodiments, a cloud memory may be provided. The dynamic to-be-shared image and the shared image of the to-be-shared map area may be stored in the cloud memory. In this way, during sharing of the shared image, the shared image of the to-be-shared map area may be directly obtained from the cloud memory.

Here, the cloud technology is a hosting technology for unifying a series of resources such as hardware, software networks in a wide area network or a local area network to achieve computation, storage, processing and sharing of data. The cloud technology is a generic term of a network technology, an information technology, an integration technology, a management platform technology, and an application technology based on application of a cloud computing business model. The resources may form a resource pool and are used on demand, which is flexible and convenient. A cloud computing technology will become an important support. The background service of a technical network system requires many computing and storage resources, for example, video websites, image websites, and more portal websites. With the high development and application of the Internet industry, each item may have its own identifier in the future and may be transmitted to a background system for logical processing. Data at different levels is separately processed, and data in various industries requires strong system support and this can only be implemented through cloud computing.

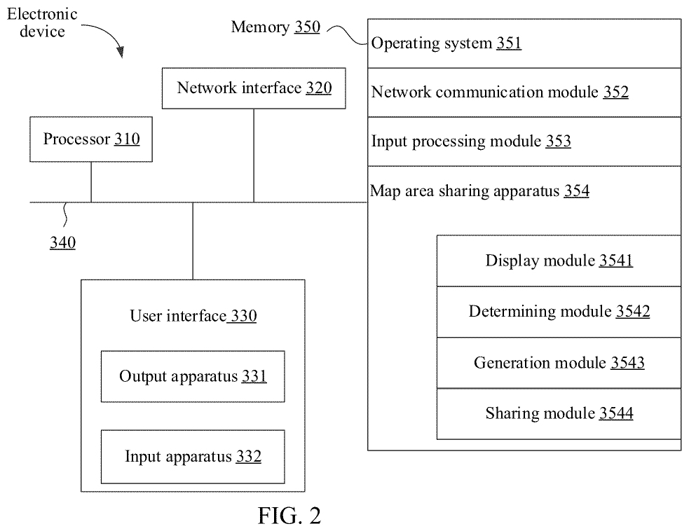

FIG. 2 is a schematic structural diagram of an electronic device according to the embodiments of the present application. As shown in FIG. 2, the electronic device may be a map area sharing device. The map area sharing device includes: at least one processor 310, a memory 350, at least one network interface 320, and a user interface 330. Components in the map area sharing device are coupled together through a bus system 340. The bus system 340 is configured to implement connection and communication between the components. In addition to a data bus, the bus system 340 further includes a power bus, a control bus, and a state signal bus. However, for clarity of description, all types of buses in FIG. 2 are marked as the bus system 340.

The processor 310 may be an integrated circuit chip having a signal processing capability, for example, a general-purpose processor, a digital signal processor (DSP), another programmable logic device, discrete gate or transistor logic device, or discrete hardware component, or the like. The general-purpose processor may be a microprocessor or any processor, or the like.

The user interface 330 includes one or more output apparatuses 331 that can display media content, and one or more input apparatuses 332.

The memory 350 may be removable, non-removable, or a combination thereof. An exemplary hardware device includes a solid-state memory, a hard disk drive, an optical disk drive, and the like. The memory 350 includes one or more storage devices away from the processor 310 in physical positions. The memory 350 includes a volatile memory or a non-volatile memory, or may include both a volatile memory and a non-volatile memory. The non-volatile memory may be a read only memory (ROM), and the volatile memory may be a random access memory (RAM). The memory 350 described in some embodiments is to include any other suitable type of memory. In some embodiments, the memory 350 may store data to support various operations. Examples of the data include a program, a module, and a data structure or other subsets or supersets, which are exemplified below.

An operating system 351 includes system programs for processing various system services and performing hardware-related tasks, such as a framework layer, a kernel library layer, and a drive layer, and is configured to implement various services and process hardware-based tasks. A network communication module 352 is configured to reach another computing device through one or more (wired or wireless) network interfaces 320. Exemplary network interfaces 320 include: Bluetooth, wireless fidelity (WiFi), universal serial bus (USB), and the like. An input processing module 353 is configured to detect one or more user inputs or interactions from the one or more input apparatuses 332 and translate the detected input or interaction.

In some embodiments, an apparatus according to some embodiments may be implemented in a software manner. FIG. 2 shows a map area sharing apparatus 354 stored in the memory 350. The map area sharing apparatus 354 may be a map area sharing apparatus in an electronic device. The map area sharing apparatus may be software in a form of a program and a plug-in, and includes the following software modules: a display module 3541, a determining module 3542, a generation module 3543, and a sharing module 3544. These modules are logical and may be arbitrarily combined in different manners or further split based on to-be-implemented functions. The functions of the modules are to be explained below.

In some other embodiments, the apparatus according to some embodiments may be implemented in hardware. As an example, the apparatus according to some embodiments may be a processor in the form of a hardware decoding processor, and is programmed to implement a map area sharing method according to some embodiments. For example, the processor in the form of a hardware decoding processor may use one or more application-specific integrated circuits (ASICs), a DSP, a programmable logic device (PLD), a complex programmable logic device (CPLD), a field-programmable gate array (FPGA), or other electronic elements.

The map area sharing method according to some embodiments may be performed by an electronic device. The electronic device may be a terminal. The map area sharing method according to some embodiments may be performed by the terminal. The following will use an example for explanation, in which the terminal implements the map area sharing method in some embodiments.

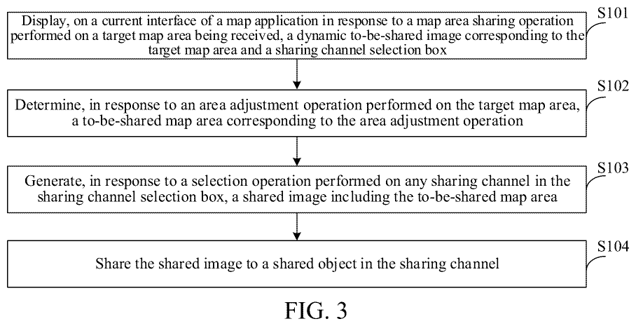

FIG. 3 is a selectable flowchart of a map area sharing method according to some embodiments. The following will make an explanation in conjunction with operations shown in FIG. 3. As shown in FIG. 3, an example in which an executive body of the map area sharing method is a terminal is used for explanation. The method includes operation S101 to operation S104 below:
Operation S101: Display, on a current interface of a map application in response to a map area sharing operation performed on a target map area being received, a dynamic to-be-shared image corresponding to the target map area and a sharing channel selection box,
the target map area being a local map area in the map application. In some embodiments, the map application may be run on the terminal. When a user enters the map application via a mini program or a client of the map application, a map may be displayed on the current interface of the map application. The target map area may be the local map area in the currently displayed map.

The map area sharing operation is a trigger operation for triggering implementation of the map area sharing method according to some embodiments. The map area sharing operation may be any trigger operation preset by a system, or may be a particular trigger operation set by a user on a map application. In the running process of the map application, an operation of the user on the terminal may be detected in real time. When it is detected that a type of the operation of the user is the same as a type of a trigger operation, it is confirmed that the map area sharing operation is received. In addition, for each type of trigger operation, a map area recognition mode corresponding to the trigger operation may further be set. In this way, when it is detected that the user performs a trigger operation on the client of the map application, the target map area may be recognized based on a map area recognition mode corresponding to the trigger operation.

For example, the map area sharing operation may be a screenshot taking operation. When it is detected that the user performs the screenshot taking operation on the client of the map application, a screenshot area is a target map area. In addition, the screenshot taking operation constitutes a trigger operation of the map area sharing method according to some embodiments, and the operations of the map area sharing method may be triggered to be performed. For another example, the map area sharing operation may be a collected-address sharing operation. When it is detected that the user requests sharing a collected address on the client of the map application, an area, in which a collected address that is to be shared by the user is located, on the map constitutes a target map area. In addition, the collected-address sharing operation constitutes a trigger operation of the map area sharing method according to some embodiments, and the operations of the map area sharing method may be triggered to be performed.

In some embodiments, when receiving the map area sharing operation, the terminal may generate the corresponding dynamic to-be-shared image based on the target map area. The dynamic to-be-shared image is an animated image. The dynamic to-be-shared image includes a plurality of frames of images, and each frame of image is an image corresponding to a new map area generated after area adjustment in a preset ratio is performed on the target map area in the map application. The dynamic to-be-shared image is played by continuously playing the plurality of frames of images.

In some embodiments, the dynamic to-be-shared image is configured for reminding the user that the current target map area is an interactive map area. The dynamic to-be-shared image is configured for reminding the user that the current target map area may be adjusted, to obtain a map area that can more accurately represent a sharing intention of the user. In some embodiments, after the map area sharing operation of the user is received, the dynamic to-be-shared image corresponding to the target map area may be automatically generated, to remind the user that the target map area is an editable and adjustable map area, thereby providing more map area options for the user. In addition, since the dynamic to-be-shared image includes the images corresponding to the new map areas generated after the area adjustment in the preset ratio is performed on the target map area. The dynamic to-be-shared image includes the plurality of frames of images of the new map areas generated based on the target map area, thereby reminding the user of selecting, from the plurality of frames of images, an image that better meets the sharing intention of the user. In this way, the user can further adjust the target map area, to form an image that is the same as or similar to any one of the plurality of frames of images, thereby improving map area sharing enthusiasm and image sharing experience of the user, and improving user viscosity of the map application.

In some embodiments, in the dynamic to-be-shared image, each frame of image is an image corresponding to a new map area generated after area adjustment is performed in a preset ratio. Therefore, in the dynamic to-be-shared image, for each frame of image, that this frame of image is an image corresponding to a new map area generated after area adjustment is performed in a ratio may further be displayed at the same time. An adjustment parameter of each frame of image may further be displayed in the displayed dynamic to-be-shared image. The adjustment parameter here includes an adjustment ratio and adjustment mode of this frame of image. The adjustment ratio may be a positive value or a negative value. If the adjustment ratio is the positive value, it indicates that positive adjustment or zoom-in adjustment is performed on the target map area. If the adjustment ratio is the negative value, it indicates that negative adjustment or zoom-out adjustment is performed on the target map area. The adjustment mode includes, but is not limited to: an area zooming adjustment and an area movement adjustment. When the adjustment mode is the area zooming adjustment, if the adjustment ratio is the positive value, it indicates that a current image is performing zoom-in adjustment on a target map area; and if the adjustment ratio is the negative value, it indicates that the current image is performing zoom-out adjustment on the target map area. When the adjustment mode is the area movement adjustment, if the adjustment ratio is the positive value, it indicates that the current image is performing movement adjustment on the target map area in a first direction; and if the adjustment ratio is the negative value, it indicates that the current image is performing movement adjustment of the target map area in a second direction. The first direction and the second direction are two opposite directions, and the first direction and the second direction may be configured in the map application.

In some embodiments, prompt information may further be displayed in the dynamic to-be-shared image. The prompt information may be prompt information in a text form. The prompt information is configured for further prompting the user that the current target map area is an interactive map area. The prompt information is configured for prompting the user that the current target map area may be adjusted, so as to obtain a map area that can more accurately represent a sharing intention of the user.

In some embodiments, after the dynamic to-be-shared image is generated, the dynamic to-be-shared image corresponding to the target map area may be displayed on the current interface of the map application. Since the dynamic to-be-shared image has a particular playback duration, the dynamic to-be-shared image may be played in a cyclic manner on the current interface, or playing of the dynamic to-be-shared image may be stopped after the dynamic to-be-shared image is played once or for a particular number of times (for example, three times), and an image of a target map area is presented on the current interface after the playing is stopped.

In some embodiments, a sharing channel selection box may further be displayed on the current interface, and channel identifications of a plurality of sharing channels are displayed in the sharing channel selection box. Each channel identification is in an interactive state. The interactive state means that a selection operation may be performed on any channel identification that has the interactive state on the current interface, to select the sharing channel corresponding to the channel identification.

In some embodiments, the dynamic to-be-shared image and the sharing channel selection box may be displayed on the current interface in an overlapping manner, or may be respectively located at different positions of the current interface, without generating overlapping of display areas.

In some embodiments, the sharing channel selection box may be displayed after the playing of the dynamic to-be-shared image is completed, or the sharing channel selection box may be displayed while the dynamic to-be-shared image is displayed.
Operation S102: Determine, in response to an area adjustment operation performed on the target map area, a to-be-shared map area corresponding to the area adjustment operation.

Here, the terminal may receive the area adjustment operation performed by a user on the target map area. In the process of displaying the dynamic to-be-shared image, the terminal may receive the area adjustment operation performed by the user. The area adjustment operation can adjust a map area in the currently displayed dynamic to-be-shared image, so as to adjust the target map area.

In some embodiments, the area adjustment operation includes area movement adjustment and area zooming adjustment. The user may perform area movement adjustment and area zooming adjustment on the target map area, to obtain new map areas, and the new map areas are to-be-shared map areas corresponding to the area adjustment operation. For example, the target map area may be moved up by 10%, and then zoom-in adjustment in 1:50 is performed on the moved map area, to obtain an adjusted to-be-shared map area.

In some embodiments, the target map area may be directly used as a to-be-shared image. The area adjustment operation is not performed on a target map area. In an implementation process, after receiving the map area sharing operation performed on the target map area, the terminal displays, on the current interface of the map application, the dynamic to-be-shared image corresponding to the target map area and the sharing channel selection box, and may invoke a timer to perform timing at the same time. If the area adjustment operation performed on the target map area is still not received when timing of the timer reaches a preset duration, the target map area is determined as the to-be-shared image. If the area adjustment operation performed on the target map area is received when timing of the timer does not reach the preset duration, the to-be-shared map area corresponding to the area adjustment operation is determined.

In some embodiments, when the dynamic to-be-shared image corresponding to the target map area and the sharing channel selection box are displayed on the current interface of the map application, prompt information about whether to perform area adjustment on the target map area may further be displayed on the current interface of the map application, and an operation button corresponding to the prompt information is displayed. The operation button includes an adjustment confirm button and an adjustment cancel button. When a selection operation performed on the adjustment cancel button is received, the target map area is directly determined as a to-be-shared image. To be specific, when a selection operation performed by the user on the adjustment cancel button is received, it indicates that the user does not perform the area adjustment operation on the target map area. Therefore, the current target map area may be directly determined as the to-be-shared map area.
Operation S103: Generate, in response to a selection operation performed on any sharing channel in the sharing channel selection box, a shared image including the to-be-shared map area.

Here, the terminal may receive the selection operation performed by a user on any sharing channel in the sharing channel selection box, to select a sharing channel for map area sharing at this time. When the selection operation performed on any sharing channel in the sharing channel selection box is received, the shared image is generated based on the to-be-shared map area, and the shared image means an image that is to be shared to the shared object.

In some embodiments, when entering the selection operation, in addition to selecting a sharing channel, the user may further select at least one object in the sharing channel. The object is an object in the selected sharing channel, for example, a shared object. For example, the sharing channel may be any instant messaging application, and the object may be a friend or a group in the instant messaging application.
Operation S104: Share the shared image to a shared object in the sharing channel.

In some embodiments, after the shared image including the to-be-shared map area is generated, the shared image is transmitted to the shared object in the selected sharing channel. In an implementation process, the shared image may be transmitted to a terminal of the shared object. For example, the shared image is transmitted to the shared object through the instant messaging application. In this case, a transmitter of the shared image is an instant messaging application account associated with an account of the shared object (i.e., a user) in the instant messaging application.

In some embodiments, after the shared image is generated, the terminal may transmit the shared image to a server of the map application, and the server of the map application shares the shared image to the shared object.

In the map area sharing method according to some embodiments, when a map area sharing operation performed by a user on a target map area is received, a dynamic to-be-shared image corresponding to the target map area and a sharing channel selection box are displayed on a current interface of a map application, each frame of image in the dynamic to-be-shared image being an image of a new map area generated after area adjustment in a preset ratio is performed on the target map area in the map application. Afterwards, a to-be-shared map area corresponding to the area adjustment operation is determined in response to an area adjustment operation performed by the user on the target map area; and in response to a selection operation performed on any sharing channel in the sharing channel selection box, a shared image including the to-be-shared map area is generated. The shared image is shared to a shared object in the sharing channel. In this way, the dynamic to-be-shared image corresponding to the target map area is displayed when a user performs map area sharing, and the user can perform area adjustment on the target map area, thereby supporting, in the map application, the user to manually adjust the target map area. The user is supported to manually adjust a map area range that the user intends to share. In this way, a deep and efficient map area screenshot sharing mode can be expanded in a map application system in a resource-intensive manner.

Some embodiments may be applied to any one of the following scenes:
Scene I: When a user finds an area (i.e., a target map area) in a map application, and intends to share the target map area with a friend, by using the map area sharing method according to some embodiments, the user may take, through a screenshot taking function of a terminal, a screenshot on the target map area displayed on a current interface, then may perform area adjustment on the target map area, to obtain a more accurate to-be-shared map area, and share the to-be-shared map area to the friend through an instant messaging application. After the friend taps, through a client of the instant messaging application, the to-be-shared map area transmitted by the user, the friend may trigger a mini program or the map application to be activated, and the to-be-shared map area is displayed in the mini program or the map application. When a terminal of the friend displays a map area through the mini program or the map application, the displayed map area is the same as the to-be-shared map area shared by the user.
Scene II: When a user collects an area (i.e., a target map area) in a map application, and intends to share the collected target map area to a friend, by using the map area sharing method according to some embodiments, the user may select the target map area through a sharing function in the map application, and may further perform area adjustment on the target map area, to obtain a more accurate to-be-shared map area, and share the to-be-shared map area to the friend through an instant messaging application. After the friend taps, through a client of the instant messaging application, the to-be-shared map area transmitted by the user, the friend may trigger a mini program or the map application to be activated, and the to-be-shared map area is displayed in the mini program or the map application. When a terminal of the friend displays a map area through the mini program or the map application, the displayed map area is the same as the to-be-shared map area shared by the user.

The following will explain the map area sharing method according to some embodiments in conjunction with Scene I above.

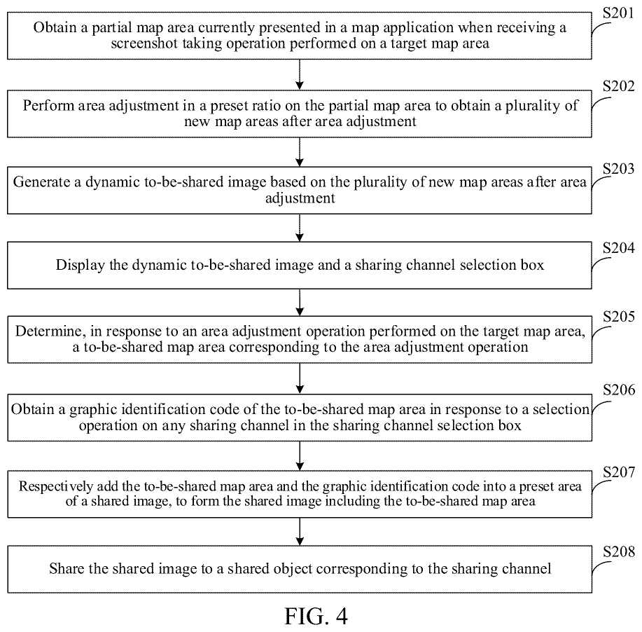

In some embodiments, the above map area sharing operation includes a screenshot taking operation, and the target map area is a partial map area currently presented in the map application. According to some embodiments, when a user takes a screenshot of the partial map area currently presented in the map application, interactive sharing may be performed on a screenshot area. FIG. 4 is another selectable flowchart of a map area sharing method according to some embodiments. As shown in FIG. 4, the method includes operation S201 to operation S208 below:
Operation S201: Obtain a partial map area currently presented in a map application when receiving a screenshot taking operation performed on a target map area.

Herein, the partial map area currently presented is a partial map area taken by the screenshot taking operation. In some embodiments, the screenshot taking operation may be taking a screenshot on a currently presented map area. In this case, an obtained target map area is the partial map area currently presented. In some other embodiments, the screenshot taking operation may be taking a screenshot on a partial map area in a currently presented map area. In this case, an obtained target map area is the partial map area currently presented. Obtaining the partial map area currently presented in the map application means obtaining the partial map area taken by the screenshot taking operation.
Operation S202: Perform area adjustment in a preset ratio on the partial map area to obtain a plurality of new map areas after area adjustment.

Here, the preset ratio may be a ratio set in advance, including a movement ratio and a zoom ratio.

In some embodiments, the area adjustment includes area movement adjustment and area zooming adjustment. The area adjustment in the preset ratio performed on the partial map area may be implemented in the following manner: performing, on a map currently loaded by the map application, the area movement adjustment in a preset movement ratio on the partial map area in at least one movement direction, to obtain a plurality of new map areas after area movement adjustment; performing, on the map, the area zooming adjustment on the partial map area in at least one zoom ratio, to obtain a plurality of new map areas after area zooming adjustment; and forming the new map areas after area adjustment by the formed new map areas after area movement adjustment and the formed new map areas after area zooming adjustment.

Here, the partial map area is the target map area, and other areas except the target map area in the entire map currently loaded by the map application are peripheral areas. In a process of running the map application, map areas currently loaded by the map application include a partial map area displayed on a current interface and an area that is not displayed on the current interface and that is located around the partial map area. During the area movement adjustment and the area zooming adjustment, the target map area is adjusted between a target map area and a peripheral area.

For example, when the target map area is moved up by 10%, the target map area may be moved towards a peripheral area that is located 10% above the target map area (or towards the north), to obtain a new map area after movement. When the target map area is zoomed in by 1:10, the target map area may be zoomed in by 1:10. In this case, a display ratio of each position presented in a zoomed-in new map area is larger, and fewer positions are presented on the current interface.

In some embodiments, a movement direction includes four directions, for example, up, down, left, and right (i.e., north, south, west, and east), and any other direction in addition to the up, down, left, and right directions. For example, the movement direction includes any direction within 360 degrees of the current interface. In some embodiments, the target map area may be moved for a plurality of times. Therefore, area movement adjustment in a plurality of directions may be performed.

The area movement adjustment and the area zooming adjustment on the target map area may be alternately performed for a plurality of times. After the area movement adjustment is performed, the area zooming adjustment is performed, and then both the area movement adjustment and the area zooming adjustment are performed. In some embodiments, a number of times, an alternation mode, and an alternation sequence of the area movement adjustment and the area zooming adjustment are not limited.
Operation S203: Generate a dynamic to-be-shared image based on the plurality of new map areas after area adjustment.

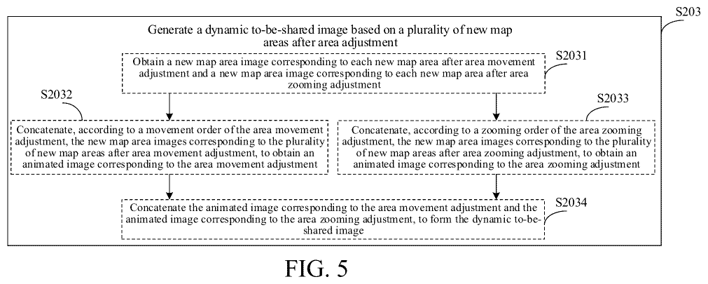

In some embodiments, FIG. 5 shows that operation S203 of generating a dynamic to-be-shared image may be implemented through operation S2031 to operation S2034 below:
Operation S2031: Obtain a new map area image corresponding to each new map area after area movement adjustment and a new map area image corresponding to each new map area after area zooming adjustment.
Operation S2032: Concatenate, according to a movement order of the area movement adjustment, the new map area images corresponding to the plurality of new map areas after area movement adjustment, to obtain an animated image corresponding to the area movement adjustment.

Here, the movement order means an order corresponding to movement directions in which the area movement adjustment is performed for a plurality of times. For example, upward movement is performed first, and then left movement is performed. During the concatenation of the new map area images corresponding to the plurality of new map areas after area movement adjustment, the new map area images corresponding to the new map areas after upward movement are concatenated in front of the new map area images corresponding to the new map areas after left movement.

In some embodiments, an instance of area reversing adjustment is performed after each instance of area movement adjustment is performed. Therefore, after a new map area image is obtained after each instance of area movement adjustment is performed, the area reversing adjustment is performed on the corresponding new map area image. Here, the area reversing adjustment means performing, according to a direction opposite to a movement direction of a previous instance of area movement adjustment, area movement adjustment on a new map area obtained after the previous instance of area movement adjustment, to implement an area movement adjustment mode for moving a new map area to an original target map area. In this way, since an instance of area reversing adjustment is performed after each instance of area movement adjustment is performed, an animated image corresponding to each instance of area movement adjustment is moving a new map area first and then restoring the new map area to the target map area. If the area movement adjustment is performed for a plurality of times, a generated animated image corresponding to the area movement adjustment is moving a generated new map area for a plurality of times. In addition, the new map area is restored to the target map area after the new map area is moved at each time to a new map area position, and then the new map area is restored to the target map area after the new map area is moved at next time to the new map area position.
Operation S2033: Concatenate, according to a zooming order of the area zooming adjustment, the new map area images corresponding to the plurality of new map areas after area zooming adjustment, to obtain an animated image corresponding to the area zooming adjustment.

Here, the zooming order is an order corresponding to an adjustment mode (for example, zooming in or zooming out) for performing a plurality of instances of area zooming adjustment. For example, zooming out is performed first, and then zooming in is performed. During the concatenation of the new map area images corresponding to the plurality of new map areas after area zooming adjustment, the new map area images corresponding to the new map areas after zooming out are concatenated in front of the new map area images corresponding to the new map areas after zooming in.

In some embodiments, an instance of area reversing adjustment is also performed after each instance of area zooming adjustment is performed. Therefore, after a new map area image is obtained after each instance of area zooming adjustment is performed, the area reversing adjustment is performed on the corresponding new map area image. The area reversing adjustment here is different from the area reversing adjustment performed after the above area movement adjustment. The area reversing adjustment here means performing reverse zooming adjustment on a new map area image. The above area reversing adjustment means performing reverse movement adjustment on a new map area image. The area reversing adjustment here means performing, according to a mode opposite to an adjustment mode of a previous instance of area zooming adjustment, area zooming adjustment on a new map area obtained after the previous instance of area zooming adjustment, to implement an area zooming adjustment mode for zooming a new map area to an original target map area. In this way, since an instance of area reversing adjustment is performed after each instance of area zooming adjustment is performed, an animated image corresponding to each instance of area zooming adjustment is zooming out a new map area first and then restoring the new map area to the target map area, or zooming in a new map area first and then restoring the new map area to the target map area. If the area zooming adjustment is performed for a plurality of times, a generated animated image corresponding to the area zooming adjustment is zooming a generated new map area for a plurality of times. In addition, the new map area is restored to the target map area after the new map area is zoomed at each time to a new map area position, and then the new map area is restored to the target map area after the new map area is zoomed at next time to the new map area position.
Operation S2034: Concatenate the animated image corresponding to the area movement adjustment and the animated image corresponding to the area zooming adjustment, to form the dynamic to-be-shared image.

In some embodiments, after a plurality of animated images are obtained, the plurality of animated images are concatenated according to an execution sequence of the adjustment actions corresponding to the animated images, to form the dynamic to-be-shared image.

In some embodiments, the new map area images corresponding to the plurality of new map areas after area movement adjustment are concatenated according to the movement order of the area movement adjustment, and the new map area images corresponding to the plurality of new map areas after area zooming adjustment are concatenated according to the zooming order of the area zooming adjustment, to respectively form the animated image corresponding to the area movement adjustment and the animated image corresponding to the area zooming adjustment. Later, the animated image corresponding to the area movement adjustment and the animated image corresponding to the area zooming adjustment are concatenated, so as to form the dynamic to-be-shared image. The dynamic to-be-shared image can dynamically present what area movement adjustment and what area zooming adjustment are performed on the target map area, thereby prompting a user to perform the area movement adjustment and the area zooming adjustment on the target map area.
Operation S204: Display the dynamic to-be-shared image and a sharing channel selection box.

Here, channel identifications of a plurality of sharing channels are displayed in the sharing channel selection box. Each channel identification is in an interactive state, and the interactive state means that the selection operation is performed on any channel identification that has the interactive state on the current interface.

The target map area is a local map area in the map application. The dynamic to-be-shared image includes a plurality of frames of images, and each frame of image is an image corresponding to a new map area generated after area adjustment in a preset ratio is performed on the target map area in the map application.
Operation S205: Determine, in response to an area adjustment operation performed on the target map area, a to-be-shared map area corresponding to the area adjustment operation.

In some embodiments, operation S205 of determining a to-be-shared map area may be implemented in any one of the following manners:
Manner I: Obtain, when the area adjustment operation is received, a target movement ratio and a target zoom ratio that correspond to the area adjustment operation, and obtain a sequence of the area movement adjustment and the area zooming adjustment in the area adjustment operation. Then, sequentially perform, on the map currently loaded by the map application, the area movement adjustment and the area zooming adjustment on the target map area according to the sequence based on the target movement ratio and the target zoom ratio, to obtain the to-be-shared map area.

Here, during the performing of the area adjustment operation, the target movement ratio and the target zoom ratio may be inputted. Alternatively, the area movement adjustment may be performed in a single-finger movement manner, or the area zooming adjustment may be performed in a two-finger zooming manner. In this case, the target movement ratio may be determined according to a distance of single-finger movement, and a two-finger zoom ratio constitutes the target zoom ratio.
Manner II: When the area adjustment operation is received, obtain position information of a central position of the to-be-shared map area and a target zoom ratio, the position information and the target zoom ratio being inputted during the performing of the area adjustment operation. Then, perform area adjustment on the target map area according to the position information and the target zoom ratio, to obtain the to-be-shared map area.

Here, a size of the to-be-shared map area may be determined according to the position information of the central position of the to-be-shared map area and the target zoom ratio. In this case, the determined size of the to-be-shared map area is a map area obtained after the area adjustment is performed on the target map area. The position information of the central position of the to-be-shared map area may be latitude and longitude values of the central position of the to-be-shared map area, or may be address information of the central position of the to-be-shared map area, for example, may be position information of a store.
Manner III: Obtain, when the area adjustment operation is received, vertex position information of two opposite vertexes (for example, an upper left vertex and a lower right vertex, or a lower left vertex and an upper right vertex) that are inputted during the performing of the area adjustment operation. Then, determine a map area position and a map area size of the to-be-shared map area on the map according to the vertex position information of the two opposite vertexes, to obtain the to-be-shared map area. The vertex position information may be latitude and longitude values of a vertex. The to-be-shared map area in some embodiments is a rectangular map area. In this way, a rectangular to-be-shared map area may be determined according to the longitude and latitude values of the upper left vertex and the lower right vertex, or the lower left vertex and the upper right vertex.
Operation S206: Obtain a graphic identification code of the to-be-shared map area in response to a selection operation on any sharing channel in the sharing channel selection box.

Here, the graphic identification code is configured for presenting the to-be-shared map area on a terminal of the shared object when the shared object scans the graphic identification code, and the presented to-be-shared map area may be a map area on which area adjustment can be performed. The graphic identification code is a unique identification code for identifying the to-be-shared map area. The to-be-shared map area may be recognized and indicated through the graphic identification code. The graphic identification code is a graphic symbol encoding system for recognizing and representing the to-be-shared map area. The graphic identification code may be any graphic identification code such as a bar code, a two-dimensional code, a LOGO, a graphic ID card, or a particular symbol.

In some embodiments, after the to-be-shared map area is generated, the graphic identification code for uniquely identifying the to-be-shared map area may be automatically generated.
Operation S207: Respectively add the to-be-shared map area and the graphic identification code into a preset area of a shared image, to form the shared image including the to-be-shared map area.

In some embodiments, a canvas of the shared image may have a preset area for adding the to-be-shared map area and a preset area for adding the graphic identification code. The to-be-shared map area and the graphic identification code may be respectively added into the corresponding preset areas in the canvas of the shared image, to form the shared image including the to-be-shared map area.

The canvas here is a canvas in an image rendering technology. In the image rendering technology, the “canvas” generally means a virtual two-dimensional or three-dimensional plane for presenting a rendered image. This concept is similar to a canvas in conventional art. However, in computer graphics, a canvas means an area for drawing and displaying an image in a computer program. In the computer graphics, canvases may include a two-dimensional (2D) canvas and a three-dimensional (3D) canvas. The 2D canvas is configured for presenting an image on a two-dimensional plane. The 2D canvas may be a pixel array on a computer screen, or may be a printing medium of a printer or another outputting device. The 3D canvas is configured for presenting an image in a three-dimensional space. The 3D canvas is usually a virtual three-dimensional coordinate system, including elements such as an object, a light source, and a camera, and may be projected onto a two-dimensional plane through a rendering technology to form a final image. In an image rendering process, computer graphics software or an engine projects information such as an object, light, or texture in a scene to the canvas, to finally generate an image that presents a realistic or artistic style.

In some embodiments, when the shared image including the to-be-shared map area is generated, viewing angle information corresponding to a viewing angle presented by the map application on the terminal may further be obtained during the performing of the selection operation. The to-be-shared map area and the graphic identification code are respectively added into the preset area of the shared image according to the viewing angle corresponding to the viewing angle information, to form the shared image.

In the map application, a viewing angle is a viewing angle and a display manner when a user views a map in the map application. Setting of the viewing angle may affect the understanding and perception of a user on map information. The viewing angle in the map application includes a due north-facing viewing angle, a vehicle head-facing viewing angle, a manual rotation viewing angle, an inclined viewing angle, and a zoom level. Regarding the due north-facing viewing angle, it means that the map application uses a due north direction of a map as reference, and keeps the direction of the map consistent with an actual direction. The due north-facing viewing angle causes the map to present a fixed direction, and a user usually uses a top of the map as the north. For the vehicle head-facing viewing angle, it means that a map uses a direction that a user faces as reference, and a direction on the map is kept consistent with a traveling direction of the user. The vehicle head-facing viewing angle is usually used in a navigation application, so that the user can clearly see a current traveling direction and a current position of the user. Regarding the manual rotation viewing angle, it means that a user may manually rotate a map to change a direction and angle of the map, to meet specific requirements. The manual rotation viewing angle allows the user to adjust a map display mode according to a preference or an actual requirement of the user. Regarding the inclined viewing angle, it means that a map may slantways display a three-dimensional effect of a terrain or a building. The inclined viewing angle is usually used in some three-dimensional map applications or aerial maps, and can provide a more vivid and real visual effect. Regarding the zoom level, in addition to a direction and angle of a viewing angle, the zoom level is also an important viewing angle parameter in the map application. A user may adjust, through zooming, a range and details that are displayed on the map, so as to obtain map information of different layers.

The viewing angle information includes an azimuth angle of the map application during map loading (it is usually by default that the due north direction of a map is upward, but in some embodiments, a shared map area is allowed to have different directions), a viewing angle direction, and a viewing angle parameter corresponding to the viewing angle direction. The viewing angle direction is a direction of a viewing angle when a map application loads a map, and the viewing angle parameter is a visual height and a viewing angle when the map is viewed according to the viewing angle direction.

For example, the map may be observed in an aerial-view manner. In this case, a top-view height and a top-view angle are viewing angle parameters (the aerial-view manner here makes a range of a shared map area a trapezoid instead of a rectangle).

In some embodiments, login information of at least one account that has been logged into the map application may further be obtained. If there is one account, the login information of the account may be added into the shared image. If there are a plurality of accounts, in response to a selection operation performed on any account, the login information of the selected account may be added into the shared image.

Here, the login information includes, but is not limited to, at least one of the following: a login avatar, user name information, and the like.

In some embodiments, if there are a plurality of accounts that have logged in, a user may select any account and add the login information of the account into the shared image.

In some embodiments, in response to an anonymous sharing operation performed on the target map area, adding the login information of the account into the shared image may further be prohibited. Here, if a user taps an anonymous sharing button on the current interface of the map application, the login information of the account may not be added into the shared image, so as to implement anonymous sharing on the to-be-shared map area.

In some embodiments, a map area description inputting operation may be received, the map area description inputting operation being configured for inputting description information of the target map area. Then, text conversion is performed on the description information, to obtain description information in a text form. Finally, the description information in the text form is added into a text description area of the shared image.

In some embodiments, description information entered by a user in any form may be received. For example, description information entered by a user in a speech form may be received, or description information entered by a user in a text form may be received, or description information entered by a user in a picture form may be received. If description information is in a non-text form, text conversion may be performed on the description information, to obtain description information in a text form.

The text description area may be located at any position in the shared image.
Operation S208: Share the shared image to a shared object in the sharing channel.

In some embodiments, during the sharing of the shared image, a sharing channel selected by a selection operation and a shared object in the sharing channel may be first determined. Then, a resource locator corresponding to the to-be-shared map area is obtained, the resource locator being configured for indicating an address of the to-be-shared map area. Finally, the shared image and the resource locator are jointly shared to the shared object in the sharing channel.

In an implementation process, when the shared image and the resource locator are shared to the shared object, the resource locator and the shared image are located in the same sharing message. In this case, the shared object also receives the sharing message having the shared image and the resource locator. The shared object may tap the resource locator to implement page jump, so that an interactive to-be-shared map area is displayed on the current interface. In some other embodiments, the resource locator and the shared image may be respectively located in two sharing messages. In this case, the shared object receives a sharing message having the shared image and a sharing message having the resource locator, and the shared object may tap the resource locator to implement page jump, so as to display an interactive to-be-shared map area on the current interface.

The following will explain the map area sharing method according to some embodiments in conjunction with Scene II above.

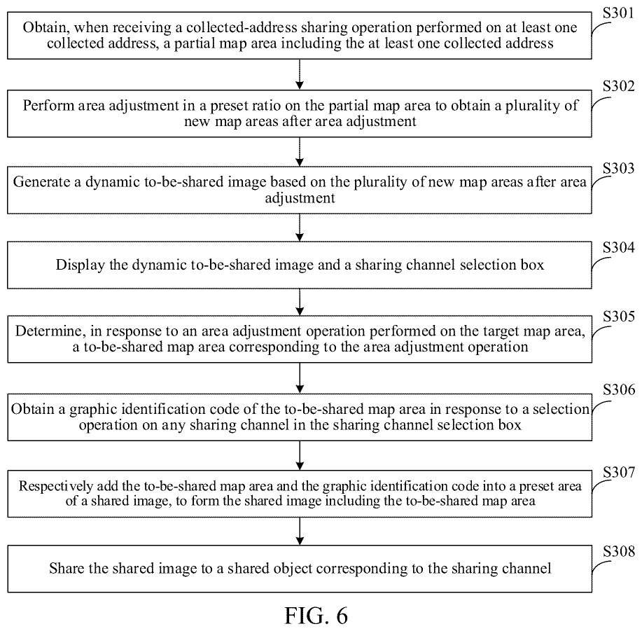

In some embodiments, the above map area sharing operation includes a collected-address sharing operation, and the collected-address sharing operation corresponds to at least one collected address. According to some embodiments, a user may perform interactive sharing on the at least one collected address that has been already collected in the map application. FIG. 6 is still another selectable flowchart of a map area sharing method according to some embodiments. As shown in FIG. 6, the method includes operation S301 to operation S308 below:
Operation S301: Obtain, when receiving a collected-address sharing operation performed on at least one collected address, a partial map area including the at least one collected address.
Operation S302: Perform area adjustment in a preset ratio on the partial map area to obtain a plurality of new map areas after area adjustment.
Operation S303: Generate a dynamic to-be-shared image based on the plurality of new map areas after area adjustment.
Operation S304: Display the dynamic to-be-shared image and a sharing channel selection box.

Here, channel identifications of a plurality of sharing channels are displayed in the sharing channel selection box. Each channel identification is in an interactive state, and the interactive state means that the selection operation is performed on any channel identification that has the interactive state on the current interface.
Operation S305: Determine, in response to an area adjustment operation performed on the target map area, a to-be-shared map area corresponding to the area adjustment operation.
Operation S306: Obtain a graphic identification code of the to-be-shared map area in response to a selection operation on any sharing channel in the sharing channel selection box.
Operation S307: Respectively add the to-be-shared map area and the graphic identification code into a preset area of a shared image, to form the shared image including the to-be-shared map area.
Operation S308: Share the shared image to a shared object corresponding to the sharing channel.

Here, an implementation process of operation S302 to operation S308 is the same as the implementation process of operation S202 to operation S208. For the implementation process of operation S302 to operation S308, refer to related explanations of the implementation process of operation S202 to operation S208.

In some embodiments, a map area sharing system may at least include a terminal and a server. A map application is installed on the terminal, and the server may be a back-end server of the map application. During implementation of the map area sharing method according to some embodiments, the terminal may receive various operations inputted by a user through a client. The terminal displays interfaces in a map application and to-be-displayed information of to-be-shared map areas. The server completes back-end computation, and data transmission between the terminal and the server is implemented through a network, so that an entire procedure of map area sharing is completed through interaction between the terminal and the server.

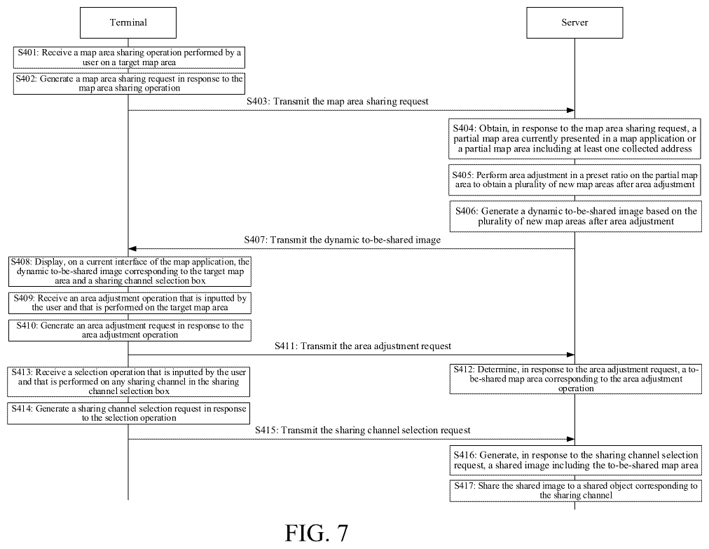

FIG. 7 is a flowchart of implementing a map area sharing method through interaction between a terminal and a server according to some embodiments. As shown in the FIG. 7, the method includes operation S401 to operation S417 below:
Operation S401: The terminal receives a map area sharing operation performed by a user on a target map area.
Operation S402: The terminal generates a map area sharing request in response to a map area sharing operation.
Operation S403: The terminal transmits the map area sharing request to the server.
Operation S404: The server obtains, in response to the map area sharing request, a partial map area currently presented in a map application or a partial map area including at least one collected address.
Operation S405: The server performs area adjustment in a preset ratio on the partial map area to obtain a plurality of new map areas after area adjustment.
Operation S406: The server generates a dynamic to-be-shared image based on the plurality of new map areas after area adjustment.

Here, the target map area is a local map area in the map application. The dynamic to-be-shared image includes a plurality of frames of images, and each frame of image is an image corresponding to a new map area generated after area adjustment in a preset ratio is performed on the target map area in the map application.
Operation S407: The server transmits the dynamic to-be-shared image to the terminal.
Operation S408: The terminal displays, on a current interface of the map application, the dynamic to-be-shared image corresponding to the target map area and a sharing channel selection box. Channel identifications of a plurality of sharing channels are displayed in the sharing channel selection box. Each channel identification is in an interactive state, and the interactive state means that the selection operation can be performed on any channel identification that has the interactive state on the current interface.
Operation S409: The terminal receives an area adjustment operation that is inputted by the user and that is performed on the target map area.
Operation S410: The terminal generates an area adjustment request in response to the area adjustment operation.
Operation S411: The terminal transmits the area adjustment request to the server.
Operation S412: The server determines, in response to the area adjustment request, a to-be-shared map area corresponding to the area adjustment operation.
Operation S413: The terminal receives a selection operation that is inputted by the user and that is performed on any sharing channel in the sharing channel selection box.
Operation S414: The terminal generates a sharing channel selection request in response to the selection operation.
Operation S415: The terminal transmits the sharing channel selection request to the server.
Operation S416: The server generates, in response to the sharing channel selection request, a shared image including the to-be-shared map area.
Operation S417. The server shares the shared image to a shared object corresponding to the sharing channel.

In some embodiments, map area sharing may be implemented by interaction between the terminal and the server. In the implementation, the terminal may receive a map area sharing operation, an area adjustment operation, and a selection operation of a user. When receiving any one of the map area sharing operation, the area adjustment operation, and the selection operation, the terminal transmits the map area sharing operation, the area adjustment operation, or the selection operation to the server. The server makes a response to the map area sharing operation, the area adjustment operation, and the selection operation respectively. The server respectively determines a dynamic to-be-shared image corresponding to a target map area, determines a to-be-shared map area corresponding to the area adjustment operation, and generates a shared image including the to-be-shared map area. Operations that need to continue to perform massive data operations are allocated to the server for execution, so that a data computation amount of the terminal can be greatly reduced, and map area sharing efficiency can be improved. Furthermore, the server may be an independent physical server, or may be a server cluster or a distributed system formed by a plurality of physical servers, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. Therefore, the computing speed can be further increased through the server cluster or the distributed system, and the map area sharing efficiency can be improved.

The following problem in the related art is solved: A map product supports a user to quickly share a screenshot page image when the user takes a screenshot on a home page of the map application, but does not support a sharing user to manually adjust a shared area and does not support a shared user to directly scan a code to view a shared range. Some embodiments aims to provide an interactive sharing method based on a screenshot area of a map. With reference to an existing surface display function of a map application, when a user shares a territory screenshot taking range, the user is supported to manually adjust a range of a to-be-shared map area and share it to a third-party medium or a friend Meanwhile, after the shared user is supported to scanning a two-dimensional code in a shared image, the shared user can open the shared image to view a map area range corresponding to the shared image.

In the technical architecture, a shared image and a corresponding two-dimensional code link are generated based on the range of the to-be-shared map area of the user, and interactability of the shared image is increased, thereby implementing customized sharing on a map surface, supporting displaying of a map area within a shared range after a two-dimensional code is scanned, expanding a map sharing capability, and then optimizing a sharing experience of a map product. Here, the map area within the shared range is the to-be-shared map area shared by the user.

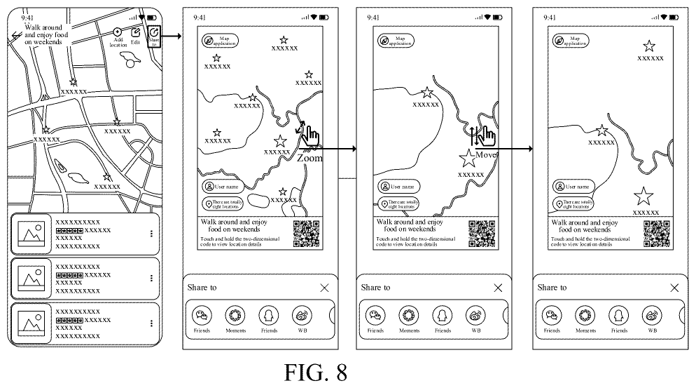

In some embodiments, in the process of running the map application, when the user takes a screenshot or shares an existing collected group through a mobile phone system, after a range of a map area that may be shared is obtained, a map area within a screen range is supported to be displayed in the shared image, and the user is supported to manually adjust the range. An adjustment mode includes: adjusting a position of a to-be-shared map area in a single-finger movement manner (i.e., area movement adjustment), and adjusting a size of a plotting scale of the to-be-shared map area in a two-finger zooming manner (i.e., area zooming adjustment). FIG. 8 is a schematic diagram of an implementation process of adjusting a size and position of a plotting scale of a to-be-shared map area according to some embodiments.

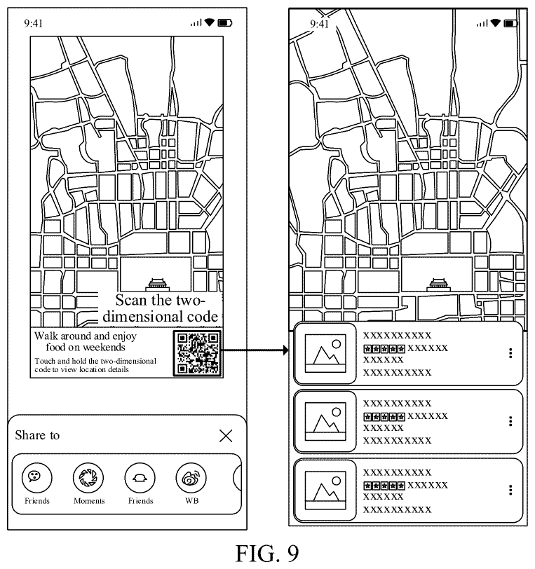

In some embodiments, a two-dimensional code link corresponding to the to-be-shared map area is displayed in the shared image, and the shared user may view, in a browser (or in a mini program, or open a corresponding map APP) by scanning the two-dimensional code, a position and area range of the map area displayed in the shared image. Moreover, the map may be moved and zoomed based on the position and area range of the map area. FIG. 9 is a schematic diagram of an implementation process of scanning a code to open and view a map that has the same area as that in a shared image according to some embodiments.

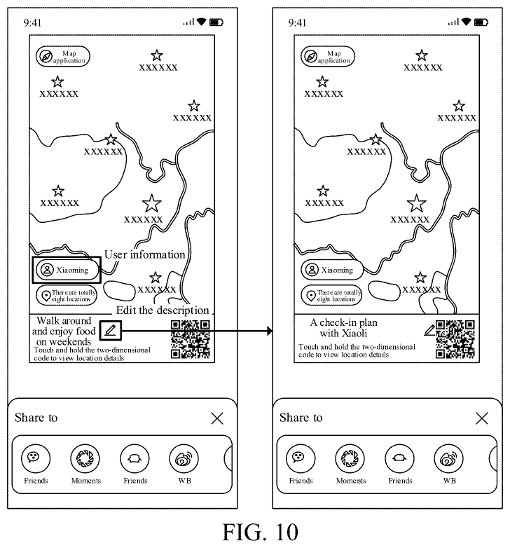

In some embodiments, the shared image further supports displaying of user login information of a shared object in a user login state, including a user name and avatar information, and supports a user to manually add description information into the shared image, thereby better conveying a sharing intention. FIG. 10 is a diagram of an interface that supports presentation of user login information and edited description information according to some embodiments.

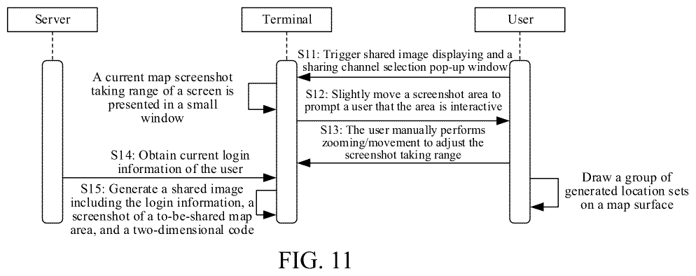

The following will explain an implementation procedure of a map area sharing method according to some embodiments. The implementation procedure in some embodiments is implemented on a terminal side. As shown in FIG. 11, an implementation procedure of an interactive map sharing function includes operation S11 to operation S15 below:
Operation S11: Trigger shared image displaying (a target map area is displayed at this time) and a sharing channel selection pop-up window (i.e., a sharing channel selection box) when an application program is in a map area screenshot taking scene or in a particular map area scene (a favorites sharing scene or the like).

Here, this operation may be implemented in the screenshot taking scene in two manners:

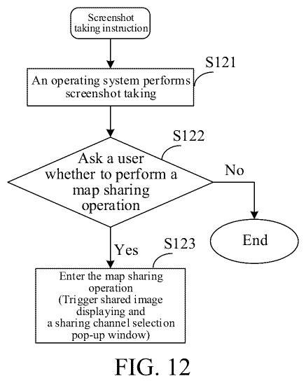

In a first manner, after an operating system of a terminal recognizes and completes a screenshot taking action (for example, screenshot taking is triggered through a particular operation, such as a screen tapping operation or three-finger downward scrolling on a screen), the current application triggers the shared image displaying and the sharing channel selection pop-up window based on a signal indicating that the operating system completes the screenshot taking action. In this manner, actually, the operating system of the terminal first performs screenshot taking, and then triggers a map sharing operation in some embodiments. In addition, an improved manner is that after the system performs the screenshot taking, the application program may ask the user whether to perform the map sharing operation (i.e., the above map area sharing method) in some embodiments. A procedure of this improved manner is shown in FIG. 12. First, operation S121: After receiving a screenshot taking instruction, an operating system performs screenshot taking. Then, operation S122: Ask a user whether to perform a map sharing operation. End the procedure if the map sharing operation does not need to be performed. Perform operation S123 if the map sharing operation may be performed, and enter the map sharing operation (trigger shared image sharing and a sharing channel selection pop-up window).

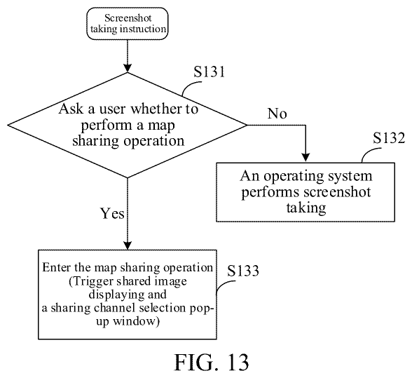

In a second manner, after a corresponding permission of an operating system of a terminal is obtained, after an input originally for triggering screenshot taking of the operating system is recognized, the screenshot taking of the operating system is not performed, but the map sharing operation in some embodiments is directly triggered. In addition, an improved manner is to ask, after an input originally for triggering screenshot taking of the operating system is recognized, a user whether to perform screenshot taking or enter related processing in some embodiments, so as to provide the user with a maximum degree of freedom. A procedure of this improved manner is shown in FIG. 13. First, operation S131: After receiving a screenshot taking instruction, ask a user whether to perform a map sharing operation. Perform operation S132 if the map sharing operation does not need to be performed. The operating system performs screenshot taking. Perform operation S133 if the map sharing operation may be performed, and enter the map sharing operation (trigger shared image sharing and a sharing channel selection pop-up window).
Operation S12: When loading a shared image, a terminal uses a dynamic loading effect to prompt that a map area is interactive, for example, slightly moves a screenshot area to prompt a user that the map area is interactive. For example, a central point of a screenshot taking range of a to-be-shared map area may be moved up by 10% and then moved down to an accurate position. In addition, a plotting scale of the to-be-shared map area is reduced by a particular level, and then is enlarged to a correct plotting scale size (for example, the plotting scale of an original map area is 1:200, it is first loaded to 1:500 and then is smoothly transitioned to 1:200).
Operation S13: The terminal fixes a current map area range after obtaining sharing channel information selected by the user, where the current map area range is a map area range obtained after the user manually performs zooming/movement to adjust the screenshot taking range, and the current map area range is configured for generating a final shared image, and the shared image is shared to a sharing channel selected by the user.

In some embodiments, there may be various manners of sharing a particular map area range. For example, a latitude and longitude of a central position of a map area and a zoom ratio of the map area may be specified. In addition, two opposite vertexes (an upper left vertex and a lower right vertex, or a lower left vertex and an upper right vertex) of a quadrangle in which the map area is located may further be specified to determine the position and size of the map area. In addition, in shared information, in addition to that the position and ratio of the map area are specified, an azimuth angle of a sharer may be shared together when the sharer shares the map (it is usually by default that the due north direction of the map is upward, but a shared map area is allowed to have different directions), and even a top-view height and top-view angle of the sharer may be shared together when the sharer shares the map observed in an aerial manner (the aerial-view manner here makes a range of a shared map area a trapezoid instead of a rectangle).
Operation S14: The terminal obtains a login state of the user. If the state indicates that the user has logged in, the terminal obtains current login information of the user, where the login information includes a login avatar, user name information, and the like of the user, and the terminal displays the login information in the shared image.

In some embodiments, operation S14 may include: allowing the user to perform selection between different accounts that have been already logged in, to select an account to complete a sharing operation, or to select to complete a sharing operation in an anonymous manner.
Operation S15: The terminal obtains a final fixed map area range of the shared image, and adds a two-dimensional code link carrying the information to the shared image, to generate a shared image including the login information, a screenshot of the to-be-shared map area, and the two-dimensional code (e.g. two-dimensional code link or QR code). The shared image may be a shared image card.

After scanning the shared image, the shared object may view page details of the to-be-shared map area in the shared image through a browser. When the user has a further navigation requirement, the user may further wake up a map application. In this case, on a user side, a group of generated location sets may be drawn on a map surface and displayed. Certainly, after the shared image is scanned, the mini program or the map application may be directly invoked to view the to-be-shared map area. In some embodiments, an associated operation after the shared image is scanned may be configured at a server end, or may be customarily configured by the user.

For a map area sharing scene during use of a map, the map area sharing method according to some embodiments supports a user to adjust a range and plotting scale of a to-be-shared map screenshot area, to achieve an optimal area sharing presentation effect. In addition, the shared user is supported to open and view the range of the to-be-shared map area, so as to implement precise sharing of the map area, thereby effectively enhancing a sharing experience. In addition, a map surface loading and interaction mode is used. With reference to a procedure of generating a shared image, sharing the shared image to a channel, and supporting out-of-terminal opening, an interactive sharing method based on a map screenshot area that is unique to a map surface scene is implemented; shared information of a map area range is effectively conveyed; and sharing scene interaction and presentation experience optimization of a map product are improved.

Here, in some embodiments, a user side part has various implementations, for example: hippy and native. The hippy is a cross-platform technical framework. A set of codes can be run on an iOS platform and an Android platform at the same time. This may reduce half of development costs and is more advantageous. In addition, in addition to a home page screenshot taking scene and a favorites sharing scene, another scene supporting presentation of a territory range on a map surface may use the sharing mode mentioned in some embodiments. In addition, during loading of the shared image, a specific screenshot taking range is related to a definition of a scene in which the shared image is located, and is not limited to a current screenshot taking range. In addition, the sharing method according to some embodiments is not limited to being applied to the map application, and is also applicable to a scene in which a browser is used to open an out-of-terminal page.

In some embodiments, content of user information is involved, for example, information such as the map area sharing operation, the target map area, the to-be-shared map area, and the collected address, a negotiation node list, and commitment information. If data related to the user information or enterprise information is involved, when some embodiments are applied to specific products or technologies, user permission or consent may be obtained, or the information is blurred to eliminate a correspondence between the information and a user. Furthermore, during example application of the relevant data collection and processing in this application, the informed consent or individual consent of a personal information subject may be obtained in strict accordance with the requirements of relevant national laws and regulations, and the subsequent data use and processing behavior is carried out within the scope of authorization of laws and regulations and the personal information subject.

The following will continue to explain an exemplary structure of a map area sharing apparatus 354 provided in some embodiments being implemented as software modules. In some embodiments, as shown in FIG. 2, the map area sharing apparatus 354 includes: a display module 3541, configured to display, on a current interface of a map application in response to a map area sharing operation performed on a target map area being received, a dynamic to-be-shared image corresponding to the target map area and a sharing channel selection box, the target map area being a local map area in the map application, the dynamic to-be-shared image including a plurality of frames of images, and each frame of image being an image of a new map area generated after area adjustment in a preset ratio is performed on the target map area in the map application; a determining module 3542, configured to determine, in response to an area adjustment operation performed on the target map area, a to-be-shared map area corresponding to the area adjustment operation; a generation module 3543, configured to generate, in response to a selection operation performed on any sharing channel in the sharing channel selection box, a shared image including the to-be-shared map area; and a sharing module 3544, configured to share the shared image to a shared object in the sharing channel.

In some embodiments, the map area sharing operation includes a screenshot taking operation, and the target map area is a partial map area currently presented in the map application. The display module is further configured to: obtain, when receiving a screenshot taking operation performed on the target map area, the partial map area currently presented in the map application; perform area adjustment in the preset ratio on the partial map area to obtain a plurality of the new map areas after area adjustment; generate the dynamic to-be-shared image based on the plurality of new map areas after area adjustment; and display the dynamic to-be-shared image and the sharing channel selection box, channel identifications of a plurality of sharing channels being displayed in the sharing channel selection box, each channel identification being in an interactive state, and the interactive state meaning that the selection operation is performed on any channel identification that has the interactive state on the current interface.

In some embodiments, the map area sharing operation includes a collected-address sharing operation, and the collected-address sharing operation corresponds to at least one collected address. The display module is further configured to: obtain, when receiving the collected-address sharing operation performed on the at least one collected address, a partial map area including the at least one collected address; and perform area adjustment in the preset ratio on the partial map area to obtain a plurality of the new map areas after area adjustment; generate the dynamic to-be-shared image based on the plurality of new map areas after area adjustment; and display the dynamic to-be-shared image and the sharing channel selection box, channel identifications of a plurality of sharing channels being displayed in the sharing channel selection box, each channel identification being in an interactive state, and the interactive state meaning that the selection operation is performed on any channel identification that has the interactive state on the current interface.

In some embodiments, the area adjustment includes area movement adjustment and area zooming adjustment. The display module is further configured to: perform, on a map currently loaded by the map application, the area movement adjustment in a preset movement ratio on the partial map area in at least one movement direction, to obtain a plurality of new map areas after area movement adjustment; perform, on the map, the area zooming adjustment on the partial map area in at least one zoom ratio, to obtain a plurality of new map areas after area zooming adjustment; and form the new map areas after area adjustment by the new map areas after area movement adjustment and the new map areas after area zooming adjustment.

In some embodiments, the display module is further configured to: obtain a new map area image corresponding to each new map area after area movement adjustment and a new map area image corresponding to each new map area after area zooming adjustment; concatenate, according to a movement order of the area movement adjustment, the new map area images corresponding to the plurality of new map areas after area movement adjustment, to obtain an animated image of the area movement adjustment; concatenate, according to a zooming order of the area zooming adjustment, the new map area images corresponding to the plurality of new map areas after area zooming adjustment, to obtain an animated image of the area zooming adjustment; and concatenate the animated image of the area movement adjustment and the animated image of the area zooming adjustment, to form the dynamic to-be-shared image.

In some embodiments, the determining module is further configured to: obtain, when the area adjustment operation is received, a target movement ratio and a target zoom ratio of the area adjustment operation, and obtain a sequence of the area movement adjustment and the area zooming adjustment in the area adjustment operation; and sequentially perform, on the map currently loaded by the map application, the area movement adjustment and the area zooming adjustment on the target map area according to the sequence based on the target movement ratio and the target zoom ratio, to obtain the to-be-shared map area.

In some embodiments, the determining module is further configured to: when the area adjustment operation is received, obtain position information of a central position of the to-be-shared map area and a target zoom ratio, the position information and the target zoom ratio being inputted during the performing of the area adjustment operation; and perform area adjustment on the target map area according to the position information and the target zoom ratio, to obtain the to-be-shared map area.

In some embodiments, the determining module is further configured to: obtain, when the area adjustment operation is received, vertex position information of two opposite vertexes that are inputted during the performing of the area adjustment operation; determine a map area position and a map area size of the to-be-shared map area on the map according to the vertex position information of the two opposite vertexes; and determine the to-be-shared map area on the map according to the map area position and the map area size.

In some embodiments, the generation module is further configured to: obtain a graphic identification code of the to-be-shared map area in response to the selection operation on any sharing channel in the sharing channel selection box; and respectively add the to-be-shared map area and the graphic identification code into a preset area of the shared image, to form the shared image including the to-be-shared map area, the graphic identification code being configured for presenting the to-be-shared map area on a terminal of the shared object when the shared object scans the graphic identification code, and area adjustment being performed on the presented to-be-shared map area.

In some embodiments, the generation module is further configured to: obtain, during the performing of the selection operation, viewing angle information of a viewing angle presented by the map application on the terminal; and respectively add the to-be-shared map area and the graphic identification code into the preset area of the shared image according to the viewing angle corresponding to the viewing angle information, to form the shared image.

In some embodiments, the apparatus further includes: an obtaining module, configured to obtain login information of at least one account that has been logged into the map application; a login information adding module, configured to: if there is one account, add the login information of the account into the shared image; and if there are a plurality of accounts, add, in response to a selection operation performed on any account, the login information of the selected account into the shared image.

In some embodiments, the apparatus further includes: a control module, configured to prohibit, in response to an anonymous sharing operation performed on the target map area, adding the login information of the account into the shared image.

In some embodiments, the apparatus further includes: a receiving module, configured to receive a map area description inputting operation, the map area description inputting operation being configured for inputting description information of the target map area; a text conversion module, configured to perform text conversion on the description information in response to the map area description inputting operation, to obtain description information in a text form; and a description information adding module, configured to add the description information in the text form into a text description area of the shared image.

In some embodiments, the sharing module is further configured to: determine the sharing channel selected by the selection operation and the shared object in the selected sharing channel; obtain a resource locator of the to-be-shared map area, the resource locator being configured for indicating an address of the to-be-shared map area; and share the shared image and the resource locator to the shared object in the selected sharing channel.

Here, the descriptions of the apparatus embodiment are similar to the descriptions of the method embodiment, and the apparatus embodiment has beneficial effects similar to those of the method embodiment, and therefore is not described in detail. Refer to the descriptions in the method embodiments of this application for technical details undisclosed in the apparatus embodiments of this application.

Some embodiments provides a computer program product, where the computer program product includes an executable instruction, and the executable instruction is a computer instruction. The executable instruction is stored in a computer-readable storage medium. When a processor of an electronic device reads the executable instruction from the computer-readable storage medium, and executes the executable instruction, the electronic device is caused to perform the foregoing method in some embodiments.

Some embodiments provides a storage medium having an executable instruction stored therein. When the executable instruction is executed by a processor, the processor is caused to perform the method in some embodiments, for example, the method shown in FIG. 3.

In some embodiments, the storage medium may be a computer-readable storage medium, for example, a memory such as a ferromagnetic random access memory (FRAM), a read only memory (ROM), a programmable read only memory (PROM), an erasable programmable read only memory (EPROM), an electrically erasable programmable read only memory (EEPROM), a flash memory, a magnetic storage, an optic disc, or a compact disc read only memory (CD-ROM). The computer-readable storage medium may include one or any combination of the aforementioned memories.

In some embodiments, the executable instructions may be in the form of programs, software, software modules, scripts, or codes, written in any form of programming language (including a compiling or interpreting language, or a declarative or procedural language), and may be deployed in any form, including being deployed as standalone programs or as modules, components, subroutines, or other units suitable for use in computing environments.

As an example, the executable instructions may, but may not necessarily correspond to files in a file system, and may be stored as part of a file that stores other programs or data, such as in one or more scripts stored in a Hyper Text Markup Language (HTML) document, in a single file dedicated to a discussed program, or in multiple collaborative files (such as files that store one or more modules, subroutines, or codes). For example, the executable instructions may be deployed to be executed on one electronic device, or on a plurality of electronic devices located at one location, or on a plurality of electronic devices distributed at a plurality of locations and interconnected through a communication network.

The foregoing descriptions are only an example of this application and are not intended to limit the scope of protection of this application. Any modification, equivalent replacement, or improvement made within the spirit and scope of this application falls within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A map area sharing method, performed by an electronic device, the method comprising:
displaying, based on a map area sharing operation performed on a target map area, a dynamic image and a sharing channel selection box on an interface of a map application,
wherein the target map area is a local map area in the map application, the dynamic image comprises a plurality of frames of images, and each frame of image corresponds to a new map area generated based on adjusting the target map area according to a preset ratio;
determining a to-be-shared map area based on an area adjustment operation performed on the target map area;
generating a shared image comprising the to-be-shared map area based on a selection operation of a sharing channel from the sharing channel selection box; and
sharing the shared image to a shared object in the sharing channel.

2. The method according to claim 1,
wherein the map area sharing operation comprises a screenshot taking operation, and the target map area is a partial map area presented in the map application,
wherein the displaying further comprises:
obtaining, based on receiving the screenshot taking operation, the partial map area;
performing area adjustment in the preset ratio on the partial map area to obtain a plurality of new map areas;
generating the dynamic image based on the plurality of new map areas; and
displaying the dynamic image and the sharing channel selection box that comprises channel identifications of a plurality of sharing channels, each channel identification being configured to receive a selection operation in an interactive state.

3. The method according to claim 1,
wherein the map area sharing operation comprises a collected-address sharing operation corresponding to at least one collected address, and
wherein the displaying comprises:
obtaining, based on receiving the collected-address sharing operation, a partial map area comprising the at least one collected address;
performing area adjustment in the preset ratio on the partial map area to obtain a plurality of new map areas;
generating the dynamic image based on the plurality of new map areas after area adjustment; and
displaying the dynamic image and the sharing channel selection box that comprises channel identifications of a plurality of sharing channels, each channel identification being configured to receive a selection operation in an interactive state.

4. The method according to claim 2,
wherein the area adjustment comprises area movement adjustment and area zooming adjustment,
wherein the performing area adjustment comprises:
performing, on a map loaded by the map application, the area movement adjustment in a preset movement ratio on the partial map area in at least one movement direction, to obtain a plurality of movement-adjusted map areas;
performing, on the map, the area zooming adjustment on the partial map area in at least one zoom ratio, to obtain a plurality of zoom-adjusted map areas; and
forming the plurality of new map areas based on the area adjustment that comprises area movement adjustment and area zooming adjustment.

5. The method according to claim 4, wherein the generating the dynamic image comprises:
obtaining movement-adjusted map area images based on the movement-adjusted map areas and zoom-adjusted map area images based on the zoom-adjusted map areas;
concatenating, based on a movement order of the area movement adjustment, the movement-adjusted map area images, to obtain an animated image of the area movement adjustment;
concatenating, based on a zooming order of the area zooming adjustment, the zoom-adjusted map area images, to obtain an animated image of the area zooming adjustment; and
concatenating the animated image of area movement adjustment and the animated image of area zooming adjustment, to form the dynamic image.

6. The method according to claim 4, wherein the determining a to-be-shared map area comprises:
obtaining a target movement ratio and a target zoom ratio of the area adjustment operation;
obtaining a sequence of the area movement adjustment and the area zooming adjustment in the area adjustment operation; and
sequentially performing, on the map loaded by the map application, the area movement adjustment and the area zooming adjustment on the target map area according to the sequence based on the target movement ratio and the target zoom ratio, to obtain the to-be-shared map area.

7. The method according to claim 1, wherein the determining a to-be-shared map area comprises:
obtaining position information of a central position of the to-be-shared map area and a target zoom ratio, the position information and the target zoom ratio being inputted during the performing of the area adjustment operation; and
performing area adjustment on the target map area based on the position information and the target zoom ratio, to obtain the to-be-shared map area.

8. The method according to claim 1, wherein the determining a to-be-shared map area comprises:
obtaining, based on receiving the area adjustment operation, vertex position information of two opposite vertexes that are inputted during the performing of the area adjustment operation;
determining a map area position and a map area size of the to-be-shared map area on the map based on the vertex position information of the two opposite vertexes; and
determining the to-be-shared map area on the map based on the map area position and the map area size.

9. The method according to claim 1, wherein the generating the dynamic image comprises:
obtaining a graphic identification code of the to-be-shared map area based on the selection operation;
adding the to-be-shared map area and the graphic identification code into a preset area of the shared image, to form the shared image comprising the to-be-shared map area;
wherein the graphic identification code is configured to present the to-be-shared map area on a terminal of the shared object based on the shared object scanning the graphic identification code,
wherein an area adjustment is performed on the presented to-be-shared map area.

10. The method according to claim 9, wherein the adding comprises:
obtaining, based on the selection operation, viewing angle information of a viewing angle presented by the map application on the terminal; and
adding the to-be-shared map area and the graphic identification code into the preset area of the shared image based on the viewing angle.

11. The method according to claim 1, further comprising:
obtaining login information of at least one account that has been logged into the map application;
adding the login information of the at least one account into the shared image; and
adding, based on a selection operation performed on a plurality of accounts, the login information of at least one of the plurality of accounts into the shared image.

12. The method according to claim 11, further comprising:
prohibiting, based on an anonymous sharing operation performed on the target map area, adding the login information of the account into the shared image.

13. The method according to claim 1, further comprising:
receiving a map area description inputting operation configured to input description information of the target map area;
performing text conversion on the description information based on the map area description inputting operation, to obtain description information in a text form; and
adding the description information in the text form into a text description area of the shared image.

14. The method according to claim 1, wherein the sharing comprises:
determining the sharing channel selected by the selection operation and the shared object in the selected sharing channel;
obtaining a resource locator of the to-be-shared map area, the resource locator being configured to indicate an address of the to-be-shared map area; and
sharing the shared image and the resource locator to the shared object.

15. A map area sharing apparatus, comprising:
at least one memory configured to store program code; and
at least one processor configured to read the program code and operate as instructed by the program code, the program code comprising:
displaying code configured to cause at least one of the at least one processor to display, based on a map area sharing operation performed on a target map area, a dynamic image and a sharing channel selection box on an interface of a map application,
wherein the target map area is a local map area in the map application, the dynamic image comprises a plurality of frames of images, and each frame of image corresponds to a new map area generated based on adjusting the target map area according to a preset ratio;
determining code configured to cause at least one of the at least one processor to determine a to-be-shared map area based on an area adjustment operation performed on the target map area;
generating code configured to cause at least one of the at least one processor to generate a shared image comprising the to-be-shared map area based on a selection operation of a sharing channel from the sharing channel selection box; and
sharing code configured to cause at least one of the at least one processor to share the shared image to a shared object in the sharing channel.

16. The apparatus according to claim 15,
wherein the map area sharing operation comprises a screenshot taking operation, and the target map area is a partial map area presented in the map application,
wherein the displaying code is further configured to cause at least one of the at least one processor to:
obtain, based on receiving the screenshot taking operation, the partial map area;
perform area adjustment in the preset ratio on the partial map area to obtain a plurality of new map areas;
generate the dynamic image based on the plurality of new map areas; and
display the dynamic image and the sharing channel selection box that comprises channel identifications of a plurality of sharing channels, each channel identification being configured to receive a selection operation in an interactive state.

17. The apparatus according to claim 15,
wherein the map area sharing operation comprises a collected-address sharing operation corresponding to at least one collected address, and
wherein the displaying code is further configured to cause at least one of the at least one processor to:
obtain, based on receiving the collected-address sharing operation, a partial map area comprising the at least one collected address;
perform area adjustment in the preset ratio on the partial map area to obtain a plurality of new map areas;
generate the dynamic image based on the plurality of new map areas after area adjustment; and
display the dynamic image and the sharing channel selection box that comprises channel identifications of a plurality of sharing channels, each channel identification being configured to receive a selection operation in an interactive state.

18. The apparatus according to claim 16,
wherein the area adjustment comprises area movement adjustment and area zooming adjustment,
wherein the displaying code is further configured to cause at least one of the at least one processor to:
perform, on a map loaded by the map application, the area movement adjustment in a preset movement ratio on the partial map area in at least one movement direction, to obtain a plurality of movement-adjusted map areas;
perform, on the map, the area zooming adjustment on the partial map area in at least one zoom ratio, to obtain a plurality of zoom-adjusted map areas; and
form the plurality of new map areas based on the area adjustment that comprises area movement adjustment and area zooming adjustment.

19. The apparatus according to claim 18, wherein the displaying code is further configured to cause at least one of the at least one processor to:
obtain movement-adjusted map area images based on the movement-adjusted map areas and zoom-adjusted map area images based on the zoom-adjusted map areas;
concatenate, based on a movement order of the area movement adjustment, the movement-adjusted map area images, to obtain an animated image of the area movement adjustment;
concatenate, based on a zooming order of the area zooming adjustment, the zoom-adjusted map area images, to obtain an animated image of the area zooming adjustment; and
concatenate the animated image of area movement adjustment and the animated image of area zooming adjustment, to form the dynamic image.

20. A non-transitory computer-readable storage medium, storing computer code which, when executed by at least one processor, causes the at least one processor to at least:
display, based on a map area sharing operation performed on a target map area, a dynamic image and a sharing channel selection box on an interface of a map application,
wherein the target map area is a local map area in the map application, the dynamic image comprises a plurality of frames of images, and each frame of image corresponds to a new map area generated based on adjusting the target map area according to a preset ratio;
determine a to-be-shared map area based on an area adjustment operation performed on the target map area;
generate a shared image comprising the to-be-shared map area based on a selection operation of a sharing channel from the sharing channel selection box; and
share the shared image to a shared object in the sharing channel.
